(19) United States
(12) Patent Application Publication
(10) Pub. No.: US 2003/0020289 A1
(43) Pub. Date: Jan. 30, 2003

(54) Impact protector for motor vehicles

(75) Inventors: Wolfgang Dohrmann, Eitorf (DE); Paul Eberhard Krug, Langenfeld (DE); Gero Kronen, Kreuzau (DE)

Correspondence Address: COHEN, PONTANI, LIEBERMAN & PAVANE, 551 FIFTH AVENUE, SUITE 1210, NEW YORK, NY, 10176, US

(73) Assignee: ZF Boge GmbH

(21) Appl. No.: 10/202,292

(22) Filed: Jul. 24, 2002

(30) Foreign Application Priority Data
Jul. 25, 2001 (DE) 101 36 297.8-21

(51) Int. Cl. B60R 19/20

(52) U.S. Cl. 293/107

(57) ABSTRACT

An impact protector for motor vehicles, comprising a bumper on at least one connecting part for connection to a chassis of the motor vehicle and an elastomeric impact strip along the bumper to dissipate impact energy in the event of a collision between the motor vehicle and an obstacle. The elastomeric impact strip includes an air hose, which can be filled with air, and a cover, the air hose being connected to an accumulator by a pressure line to form an air cushion. The air pressure in the air hose is controllable by means of a valve, which is connected by an electronic control line to a detection sensor system for detection of the magnitude of the impact to be cushioned immediately before the collision of the motor vehicle, in particular with pedestrians.

### BACKGROUND OF THE INVENTION

1. Field of the Invention

The invention relates to an impact protector for motor vehicles, comprising a bumper on at least one connecting part for connection to a chassis of the motor vehicle and an elastomeric impact strip along the bumper to dissipate impact energy in the event of a collision between the motor vehicle and an obstacle, the elastomeric impact strip comprising an air hose, which can be filled with air, and a cover.

2. Description of the Related Art

Cushioned bumpers, especially those that are cushioned by an air cushion, form part of the prior art. They are intended to protect the motor vehicle and the obstacle struck by the vehicle in the event of a collision. However, foam rubber or permanent pressurized-air fillings in air cushions have a very hard spring characteristic, which primarily benefits the motor vehicle with its relatively large mass, but not the obstacles. Although cushioning of the bumper in accordance with the abovementioned criteria is better than nothing, it is far from adequate specifically for pedestrians, riders of two-wheeled vehicles or obstacles with a similar mass, compared with a bumper fitted with a large-volume air hose at a relatively low air pressure. By this means, the characteristic of the force upon impact against the bumper could be distributed over a larger travel, and the costly injuries or destruction caused could be reduced.

### SUMMARY OF THE INVENTION

The object of the invention, is to create an impact protector along the bumper that is fitted with an air hose to absorb impact energy and, in addition to protecting the motor vehicle itself, also provides protection for lighter obstacles, such as two-wheeled vehicles or pedestrians.

As a solution to this object, the proposal is to fit the motor vehicle with a detection sensor system and an accumulator, with the aid of which an active damping system for the protection in equal measure of the motor vehicle and lighter obstacles, e.g. pedestrians, can be achieved.

The accumulator, which is preloaded with a high pressure, is connected by a pressure line first of all to a valve and, via the latter, to an air hose, which is connected to the bumper and extends over the entire length of the bumper. When the valve is opened, the air hose can be inflated in fractions of a second. The valve is controlled by means of an electrical control line, activation of this valve being initiated by the detection sensor system, which can calculate the size and mass of the obstacle even before the motor vehicle collides with it and can thus meter the appropriate pressure charge for the expected collision to the air hose by controlling the valve.

With a cover, the air hose forms an impact strip, which is integrated optically into the bumper in the state of rest. In this arrangement, the cover is latched into the bumper and covers the air hose with respect to the outside. If the air hose is abruptly inflated in the event of a collision, the cover is thereby unlatched and lifts off from the bumper. The distance that the cover travels as it lifts off up to the final extended position with the air hose fully inflated is available in full as a damping spring travel in the event of a collision.

The air hose is preferably composed of elastomer, which, by virtue of the progressive tensile stress of its wall, provides damping with a progressive rise in force over the compression travel in the event of a brief impact. The absorbed force thus increases progressively over the compression travel. This property of the air hose, combined with the operation of the cover, are the crucial factors in providing protection for pedestrians, the protection provided being the optimum with the means according to the invention. If the air hose were to collide with the obstacle without a cover, then, in the absence of the necessary resistance, the obstacle would force its way into the air hose as a point load as far as the hard bumper, resulting in injury or destruction. With the aid of the cover, which should preferably be composed of a tough but flexible plastic, the point load is distributed over a longer length of the impact strip. It is possible to divide the air hose into a plurality of chambers, which are each filled by a respective valve, the valves being operatively connected to the accumulator and the detection sensor system. The chambers are arranged underneath the cover and have the effect that, if there is an impact on one side, only the chambers involved in the collision are inflated. In the case of simultaneous filling of the chambers with compressed air, the respective pressure does not have to fully equal the pressure of a single chamber; on the contrary, it can be lower in order to achieve the same effect that is achieved with an air hose without chambers.

The action of an impact protector with an impact strip on the bumper is explained with reference to a number of drawings.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a chassis of a motor vehicle with a bumper, on which an impact strip, comprising an air hose and a cover, is arranged, the air hose being connected to an accumulator,

FIG. 2 shows a diagrammatically illustrated characteristic of a force in the event of a collision, against the damping travel of the air hose of the impact strip,

FIG. 3 shows a function diagram relating to the standby condition of the impact protector with the cover still latched in, and

FIG. 4 shows a function diagram relating to the active condition in expectation of a collision with the cover unlatched and the air hose inflated.

### DETAILED DESCRIPTION OF THE PRESENTLY PREFERRED EMBODIMENTS

According to FIG. 1, a bumper 1 is arranged on a chassis 2 of a motor vehicle by means of two connecting parts 3, the bumper having an impact strip 4, which preferably extends over the entire length of the bumper 1, on the side facing away from the chassis 2. The impact strip 4 comprises an air hose 5 and a cover 12, an air cushion 6 being provided through the interaction of the bumper 1, the air hose 5 and the cover 12. The air hose 5 is connected to an accumulator 8 by a pressure line 9, the pressure line 9 containing a valve 7 that can be controlled by a detection sensor system 10. This detection sensor system 10 is connected to the pressure line 9 by an electrical control line 11.

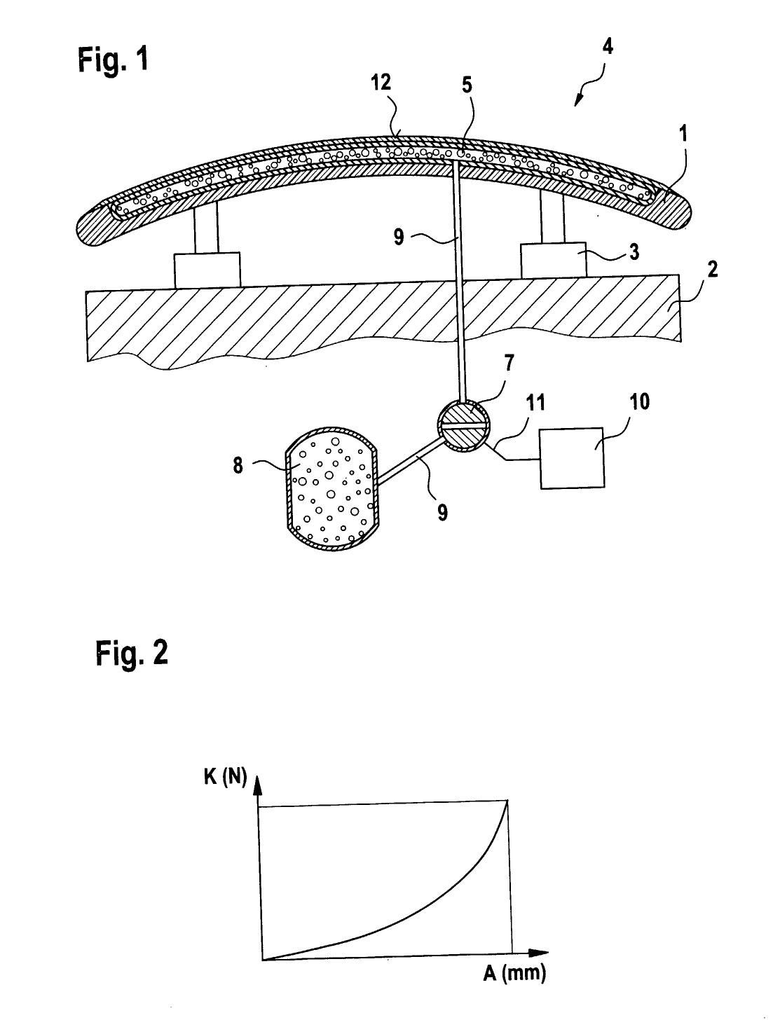

FIG. 2 illustrates a characteristic V of a damping force K against an air cushion travel A, the characteristic V rising progressively over the entire air-cushion travel A up to the maximum damping force K. The characteristic V can be varied through appropriate choice of the elements involved in impact damping.

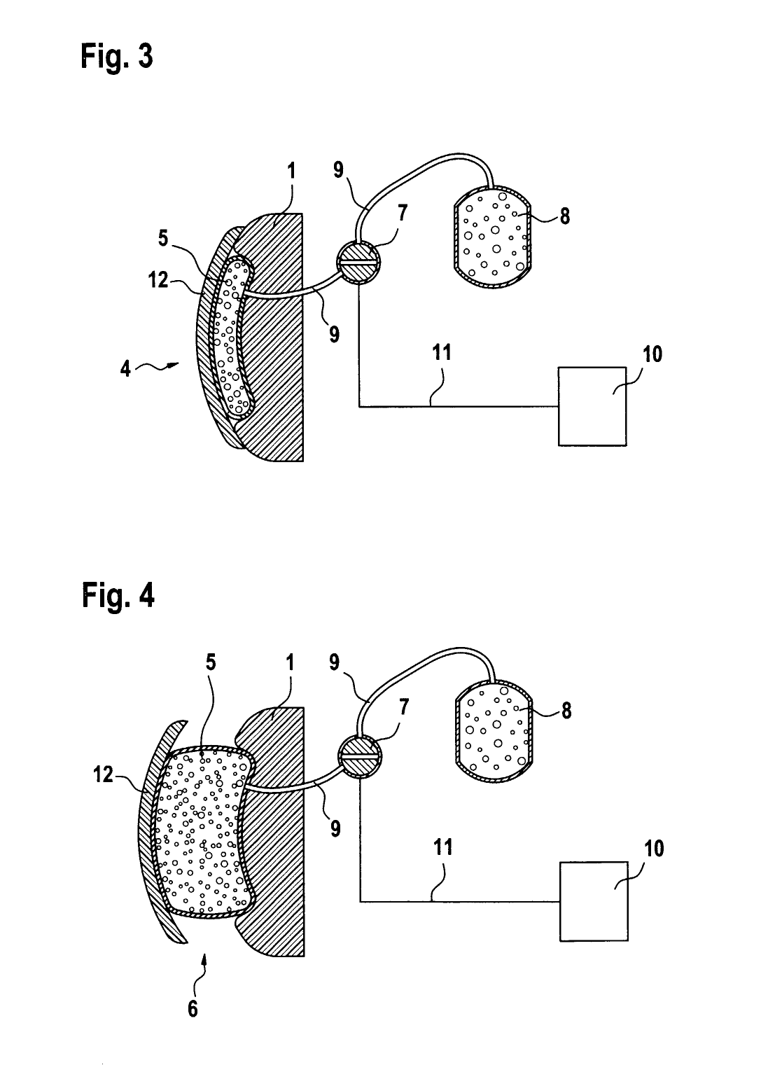

FIG. 3 illustrates diagrammatically how the air hose 5 is integrated into the bumper 1 and covered by the cover 12, which is latched into the bumper 1. The condition shown here is the standby condition of the impact protector with an impact strip 4, into which the cover 12 is still latched and thereby covers the air hose 5 satisfactorily in the bumper 1.

A function diagram shown in FIG. 4 illustrates the active condition of the impact protector in expectation of a collision. In this case, the detection sensor system 10 has opened the valve 7, thereby allowing the accumulator 8 to inflate the air hose 5, thereby unlatching the cover 12 and displacing it in the direction of the obstacle by the air-cushion travel A.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. An impact protector for a motor vehicle, said impact protector comprising
a bumper for mounting to a chassis of a motor vehicle by at least one connecting part,
an elastomeric impact strip on said bumper for dissipating impact energy in the event of a collision between a motor vehicle and an obstacle, said elastomeric impact strip comprising an air hose which can be filled with air and a cover over said air hose,
an accumulator connected to said air hose by a pressure line to form an air cushion in said air hose, and
a control valve in said pressure line for controlling air pressure in said air hose.

2. An impact protector as in claim 1 further comprising a detection sensor system connected to said control valve by an electrical control line, said detection sensor system opening and closing said control valve in dependence on the magnitude of forces expected during the collision with an obstacle, whereby the air pressure in said air hose can be controlled.

3. An impact protector as in claim 1 wherein said cover is normally latched to said bumper, said cover being unlatchable and moveable away from said bumper as said air pressure in said air hose is increased to form said air cushion.

4. An impact protector as in claim 3 wherein said cover comprises a material which is sufficiently stiff to distribute impact loading during said collision over a large area of said air hose.

5. An impact protector as in claim 1 wherein said air hose comprises a plurality of chambers which can be filled independently of one another with compressed air from said accumulator.

6. An impact protector as in claim 5 wherein said chambers are connected to said accumulator by at least two of said pressure lines and respective said control valves.

7. An impact protector as in claim 1 wherein said air hose consists of an elastomer which achieves a progressively higher damping characteristic by virtue of progressively higher tensile stress during impact.
